(19) United States
(12) Patent Application Publication
(10) Pub. No.: US 2011/0215919 A1
(43) Pub. Date: Sep. 8, 2011

(54) Apparatus and Method for Power and Performance Monitoring of Electric Appliances

(76) Inventor: Daniel Ray Hernandez, Austin, TX (US)

(21) Appl. No.: 12/718,460

(22) Filed: Mar. 5, 2010

(51) Int. Cl. G08B 19/00; G08B 21/00

(52) U.S. Cl. 340/521; 340/654; 340/636.1; 340/584; 340/585

(57) ABSTRACT

A power monitor for an electrically powered device provides audible and/or visual alarms in the event of a power failure in a particular branch circuit. A timer records the duration of the power outage and reports the result on a built-in display. Optional performance sensors may monitor and report the condition of the electrically powered device being monitored. A representative embodiment is a monitor for a refrigerator/freezer. A temperature sensor in each of the two compartments triggers an alarm if pre-set temperature limits are exceeded. The power monitor comprises an internal, rechargeable battery which powers the device during a power outage.

### CROSS-REFERENCE TO RELATED APPLICATIONS

None

### STATEMENT REGARDING FEDERALLY SPONSORED RESEARCH OR DEVELOPMENT

Not Applicable

### BACKGROUND OF THE INVENTION

1. Field of the Invention

This invention relates to electrical equipment. More particularly, it relates to line power monitors and performance monitors for appliances such as refrigerators, freezers and the like.

2. Description of the Related Art Including Information Disclosed Under 37 CFR 1.97 and 1.98

A total electrical power failure in a home or other building is usually immediately apparent to the occupants—lights go out and all non-battery-powered electrical devices stop working. However, the failure of a single branch circuit may not be noticed so easily.

Many homes, especially those built or rewired recently, have dedicated circuits for certain appliances such as refrigerators and freezers. Because of this, a homeowner may not immediately be alerted to a loss of power to the appliance. If, for example, the circuit breaker on a dedicated branch were to trip, it would not be immediately obvious since other circuits (and the devices powered by them) would not be effected. Loss of power to a refrigerator or freezer can result in the spoilage of the contents in a relatively short time. Accordingly, it is important that a homeowner be made promptly aware of a loss of power to such a device. Loss of power to many other electrically powered devices can have severe consequences—e.g., medical devices, freeze-protection equipment, sump pumps, security systems, pet or livestock feeders and heaters. Hence the need for alerting devices.

Some devices which are normally powered by the electrical mains can benefit from having an alternative power supply. An uninterruptible power supply (also known as an uninterruptible power source, UPS or battery backup), is an electrical apparatus that provides emergency power to a load when the input power source, typically the utility mains, fails. A UPS differs from an auxiliary or emergency power system or standby generator in that it can provide instantaneous or near-instantaneous protection from input power interruptions by means of one or more attached batteries and associated electronic circuitry. The on-battery runtime of most uninterruptible power sources is relatively short—5 to 15 minutes being typical for smaller units—but sufficient to allow time to bring an auxiliary power source on line, or to properly shut down the protected equipment in an orderly fashion.

However, devices which draw substantial power over a significant period of time (e.g., a refrigeration unit) cannot benefit from being connected to a conventional UPS. The cost and size of the batteries required to power a typical home refrigerator/freezer for even a couple of hours would be prohibitive for most homeowners.

Another problem with power interruption to refrigerators and freezers is that a power loss can occur, the temperature can increase to the point of allowing food to spoil, the power can subsequently be restored and the unit cooled back down to its normal operating point all without the knowledge of the owner (who may have been away from home on vacation).

What is needed is a device which can alert a user to a loss of utility power and report the duration of the power outage.

### BRIEF SUMMARY OF THE INVENTION

The invention is a power and performance monitor for home appliances—especially refrigerators and freezers.

The monitor plugs into a wall electrical outlet and the appliance plugs into the monitor—i.e., the appliance is in series with the monitor. In some embodiments, the monitor has a “piggyback” style plug into which the appliance is plugged.

The monitor includes alarms—audible (buzzer), visible (flashing light), or both—to signal a power interruption. The monitor has an internal, rechargeable battery that powers the alarms. The battery is kept charged by an internal battery charging circuit.

The monitor also includes battery-powered circuitry which records the duration and/or time of the power interruption(s). This allows a homeowner to know when and how long the refrigerator or freezer was off. This information can be displayed on a built-in display and/or downloaded via a USB port or the like to a computer or memory stick.

An optional feature is one or more sensors that monitor the performance of the appliance. For a refrigerator/freezer monitor, the sensor comprises a temperature probe(s). The monitor can be set with minimum and maximum values which will trigger the alarm if exceeded. Circuitry can also be provided to record the temperature versus time either continuously or following a power interruption.

In certain embodiments, only the maximum temperature reached during a power interruption may be recorded.

### BRIEF DESCRIPTION OF THE SEVERAL VIEWS OF THE DRAWING(S)

FIG. 1 is a perspective view of an apparatus according to a first embodiment of the invention.

FIG. 2 is a functional block diagram of the device illustrated in FIG. 1.

FIG. 3 is a flowchart of one particular method of operation of an apparatus according to the invention.

### DETAILED DESCRIPTION OF THE INVENTION

A representative embodiment of the invention monitors the temperature in either or both the refrigerator and freezer compartments of a refrigeration unit. The device has a countdown clock that is activated by an elevation in temperature and lets the consumer know the duration the temperature of the compartment was out of range as well as the highest temperature reached. It monitors the temperature via a probe(s) placed in the freezer and/or the refrigerator compartments. The device can detect a power failure as well as an elevation in temperature due to the door being left ajar or a malfunction of the cooling unit. Warning may be given by audible means such as an audio buzzer and/or by visual means such as a blinking light. The device preferably includes a charging circuit and a rechargeable battery that allows the unit to provide a continued warning signal and time recording despite a power failure of the utility mains. A piggy-back style plug allows the power of the circuit to be monitored while not supporting the load of the refrigeration unit being monitored. Unlike a UPS, a device according to the invention need not provide battery back-up power for the appliance being monitored.

An apparatus according to the invention may have a reset button to reset the unit and a test switch to allow an automated check of its circuitry. One particular preferred embodiment has a 6-foot power cord with the piggy-back style plug which allows the device to be plugged into a wall outlet and then set above or beside the unit to be monitored (which is plugged into the back of the piggyback plug so as to ensure that the monitor and the appliance being monitored share the same power supply).

The invention may best be understood by reference to one particular illustrative embodiment which is shown in the drawing figures.

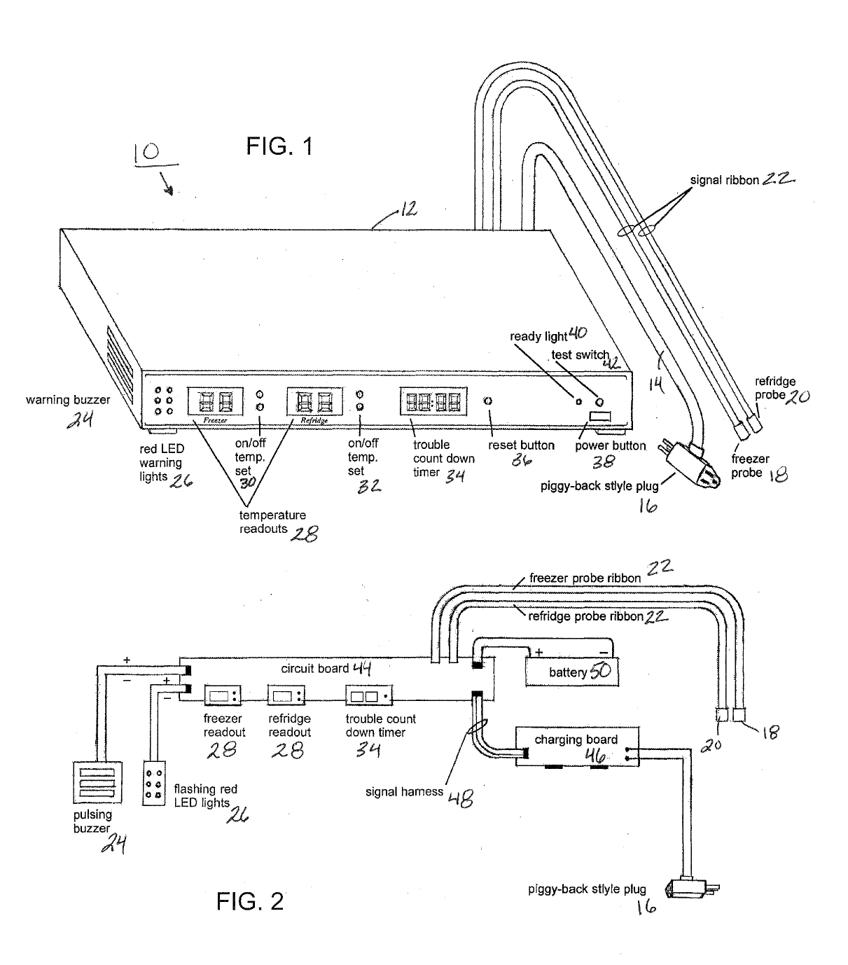

Referring to FIG. 1, a refrigerator/freezer power and temperature monitor 10 is shown housed in chassis 12. Extending from chassis 12 are power cord 14 (which terminates at plug 16) and signal cables 22 which connect to freezer temperature probe 18 and refrigerator temperature probe 20. Plug 16 may be a “piggyback” type plug which permits the refrigerator/freezer being monitored to share the same power outlet as monitor 10. This arrangement ensures that monitor 10 is observing the very same power being supplied to the appliance being monitored.

Freezer probe 18 and refrigerator probe 20 may be thermistors or any other temperature-sensing devices known in the art. Signal cables 22 may be ribbon cables which are particularly suited for routing between the cabinet of the refrigerator/freezer and the magnetic door seal commonly used on household refrigerators and freezers.

Monitor 10 includes an audible warning device (such as warning buzzer 24) and chassis 12 may have slots or other openings to permit the sound to escape. Monitor 10 also includes a visual warning device such as warning lights 26 which may be flashing light emitting diodes (LEDs).

Monitor 10 may comprise one or more display panels for displaying test results. In the embodiment illustrated in FIG. 1, monitor 10 includes separate digital displays 28 for the freezer and refrigerator temperatures and digital timer display 34. The displays may be liquid crystal displays (LCDs), LED displays, vacuum fluorescent displays, mechanical drum counter displays or any suitable display known in the art.

Controls 30, which may be pushbutton switches, are provided for enabling/disabling the freezer temperature monitor and setting the threshold freezer temperature for the alarm. Controls 32 may perform the same functions for the refrigerator temperature monitor.

Reset button 36 may be provided for re-initializing monitor 10 as described more fully, below. Ready light 40 may be provided on the front panel of monitor 10 to indicate that the unit is powered up and functioning normally. Test switch 42 may be provided to initiate a self-test function and/or activate the audible and visual alarms to ensure that they are fully functional.

Power switch 38 may be provided disable monitor 10. In one particular preferred embodiment, power switch 38 comprises a button which must be depressed and held for three seconds to power down monitor 10. This arrangement helps to ensure that the monitor is not inadvertently shut off. It will be appreciated by those skilled in the art that piggyback-style plug 16 permits monitor 10 to be switched off without interrupting power to the refrigerator/freezer (or other appliance) to which it is connected. Piggyback-style plug 16 connects monitor 10 in parallel with whatever is plugged into the back (female outlet) of the plug.

Referring now to FIG. 2, certain subsystems of monitor 10 are shown in block diagram form. Circuit board 44 may comprise one or more processors, memory devices and interface chip sets as well as temperature readouts 28 and timer display 34. Connections may also be provided for buzzer 24, LED warning flasher 26 and temperature probes 18 and 20. Charging circuit board 46 may comprise one or more power supplies for providing power to circuit board 44 and charging current to rechargeable battery 50. Under normal circumstances, charging board 46 receives AC electrical power from plug 16 (via power cord 14) and converts it to low-voltage DC to power the electrical components on circuit board 44 (via harness 48) and also provides a trickle charge to maintain battery 50 in a fully-charged state. In certain embodiments, charging board 46 may also include means for signaling circuit board 44 (via signal harness 48) that the AC power being supplied via plug 16 and power cord 10 has failed or is failing and that circuit board 44 should switch to battery 50 to supply its power needs. In similar fashion, charging board 46 may signal circuit board 44 when power is restored at plug 16. In yet other embodiments, charging board 46 may comprise a rapid charger for quickly recharging battery 50 after power is restored.

It will be appreciated by those skilled in the art that power supply 46 in combination with battery 50 comprises an uninterruptable power supply (UPS) for the circuits on circuit board 44. A UPS designed for powering DC equipment is very similar to an online UPS, except that it does not need an output inverter, and the powered device may not need a power supply—i.e., a subsystem for converting high voltage AC into low voltage DC. Rather than converting AC to DC to charge batteries, then DC to AC to power the external device, and then back to DC inside the powered device, the equipment may accept DC power directly and thereby allow one or more conversion steps to be eliminated.

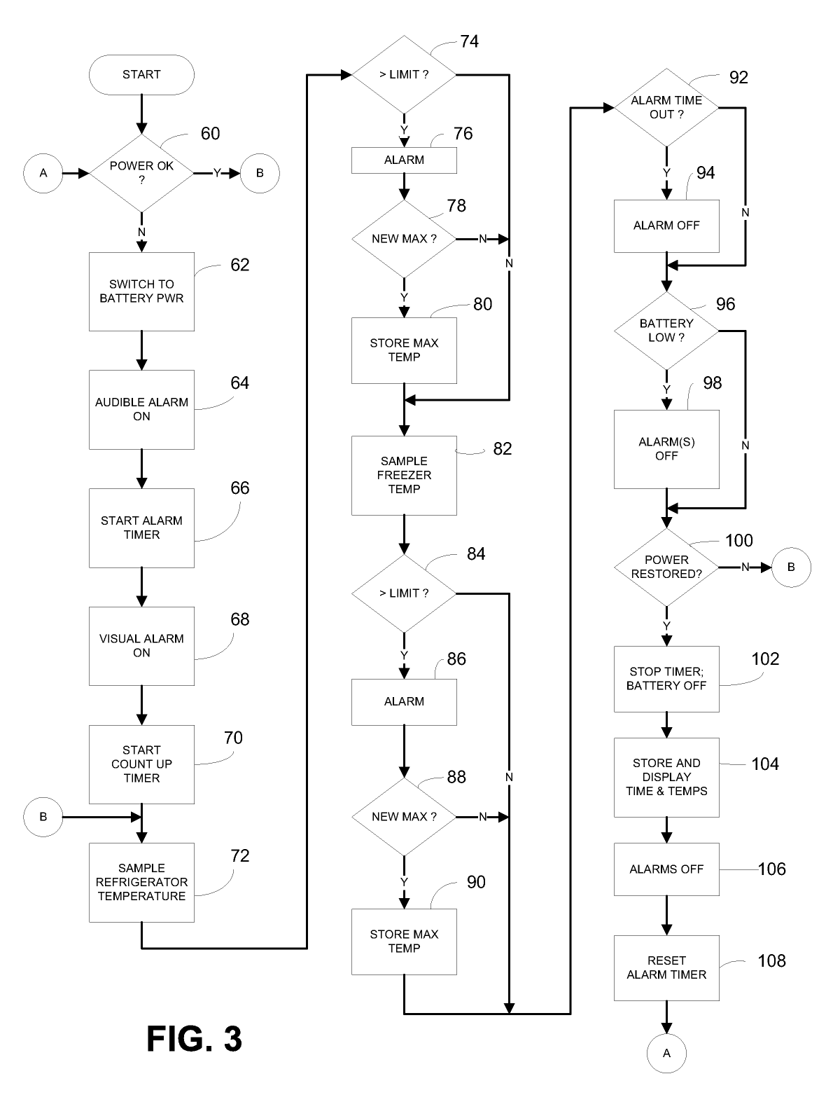

One particular method for monitoring the power supplied to and the temperatures maintained by a refrigerator/freezer using the apparatus illustrated in FIGS. 1 and 2 is shown in flowchart form in FIG. 3. In Figure, “Y” denotes a “yes” or positive test result and “N” indicates a “no” or negative test result.

A power and temperature monitoring process according to the invention may begin at decision diamond 60 which is responsive to a test of the electrical supply. Test parameters may be pre-programmed into the device—e.g., minimum and maximum acceptable voltage levels, AC frequency limits, minimum power interruption interval (to avoid nuisance activations due to momentary power loss), etc.

If the power is found to be within acceptable parameters, the process proceeds to step 72 for temperature monitoring. If, however, a fault in or complete failure of the power is detected, the system commands a switch to battery power (at box 62), activates the audible alarm (box 64) and starts a timer for the audible alarm (at box 66). The system may include a pre-programmed time limit for the audible alarm to extend the battery life and avoid unnecessary user aggravation. In certain embodiments, the system may include a “warning buzzer silence” button which deactivates the audible alarm when depressed.

The system also activates the visual alarm (at 68) and, at box 70, starts a timer which keeps track of the time duration of the power outage.

At box 72, the temperature of probe 20 (which may be positioned inside the refrigerator) is sampled and compared (at diamond 74) to a pre-set maximum acceptable temperature. If the temperature exceeds the pre-set limit (Y branch at 74), the audible and/or visual alarms may be activated (at 76) if they were not previously activated in response to a power failure (at 64 and 68).

The system may store the maximum temperature reached within the refrigerator by storing the sampled temperature and comparing subsequent temperature measurements to the stored value. If the sampled temperature is greater than the previously stored temperature (Y branch at 78), the new maximum temperature is stored (at 80).

At box 84, the temperature of probe 18 (which may be positioned inside the freezer section) is sampled and compared (at diamond 84) to a pre-set maximum acceptable freezer temperature. If the temperature exceeds the pre-set limit (Y branch at 84), the audible and/or visual alarms may be activated (at 86) if they were not previously activated in response to a power failure (at 64 and 68) or by excessive temperature in the refrigerator section (at 76).

The system may store the maximum temperature reached within the freezer by storing the sampled temperature and comparing subsequent temperature measurements to the stored value. If the sampled temperature is greater than the previously stored temperature (Y branch at 88), the new maximum temperature is stored (at 90).

At diamond 92, the system compares the current value of the alarm timer (which was started at 66) to the pre-set time-out value. If the time limit has expired (Y branch at 92) the audible alarm is silenced at step 94. To further extend the battery life of the monitor, a test may be made (at 96) to determine whether the battery is nearly discharged. If so (Y branch at 96), all alarms may be deactivated (at 98) to further reduce the drain on the battery.

At step 100, a subsequent test is made of the power supply to determine whether utility power has been restored. In certain embodiments, this test may include a timer function so as to require the power to be continuously on for a certain period of time before it is deemed to be fully “restored” (Y branch at 100). If the power is still off (N branch at 100), the process repeats, starting at step 72, with additional samples being taken of the temperatures within the refrigerator and freezer.

However, if the power has been restored (Y branch at 100), the outage duration timer (which was started at 70) is stopped (at 102) and operation on battery power is discontinued (also at 102). At this point, a rapid charger (if so equipped) may be activated to quickly restore the capacity of the battery in the event that power is lost again within a short period of time.

At 104, the device displays (on temperature readouts 28 and timer display 34) the maximum temperatures reached in both the refrigerator and the freezer during the power outage as well as the total duration (e.g., in hours and minutes) of the power interruption. If not previously deactivated at 94 and/or 98, the alarms are then shut off (at 106) and the alarm timer is reset (at 108). The process then repeats continuously with the power check at diamond 60.

In certain other embodiments, a plurality of timers may be provided to record a plurality of power outages which may occur between system resets. In still other embodiments, timers may be provided to record and report the length of time the refrigerator and/or freezer sections exceeded their pre-set temperature limits. In this way, a malfunction of the refrigerator/freezer could be detected and reported to a homeowner even if there were no power outage.

In some embodiments, temperature and time values may be retained and displayed until the unit is manually reset by, for example, user activation of reset button 36. Certain embodiments may be programmed to provide an automatic reset if one or more temperature limits are not exceeded during a power outage—i.e., a power outage of no consequence.

It should be appreciated that the invention has been illustrated with reference to a particular embodiment optimized for use with a refrigerator/freezer. However, the invention may be used in power monitors intended for other electrically-powered devices. By way of example only, the monitor may be used with a sump pump and the temperature probes 18 and 20 of monitor 10 could be replaced with float switches that would alert a homeowner to rising water in his or her basement. In yet another example, the monitor may be used with an aquarium heater and the monitor equipped with a sensor responsive to the water temperature of the aquarium. Those skilled in the art will apply the method and apparatus of the invention to power monitors intended for other critical equipment either with or without auxiliary sensors.

Although the invention has been described in detail with reference to certain preferred embodiments, variations and modifications exist within the scope and spirit of the invention as described and defined in the following claims.

What is claimed is:

1. An electrical power monitor comprising:
a line power detector;
a power failure duration timer connected to the line power detector such that the timer starts when the line power detector detects a line power failure and stops when the line power detector detects a restoration of line power;
a display connected to the timer that displays the timer count;
a battery connected to the timer and the display such that the battery supplies power to the timer and the display during line power failures.

2. An electrical power monitor as recited in claim 1 further comprising a line power cord having a unitized male electrical plug and a female electrical receptacle in parallel electrical connection connected to the line power detector.

3. An electrical power monitor as recited in claim 1 wherein the line power detector comprises a timer which delays the starting of the power failure duration timer for a pre-set period of time after a power failure is detected.

4. An electrical power monitor as recited in claim 1 wherein the line power detector comprises a timer which delays the stopping of the power failure duration timer for a per-set period of time after a restoration of line power is detected.

5. An electrical power monitor as recited in claim 1 further comprising an audible alarm that sounds when the line power detector detects a failure of line power.

6. An electrical power monitor as recited in claim 5 further comprising a timer that silences the audible alarm after a pre-set interval of time.

7. An electrical power monitor as recited in claim 1 further comprising a visible alarm connected to the line power detector that is activated when the line power detector detects a line power failure.

8. An electrical power monitor as recited in claim 7 wherein the visible alarm comprises flashing light emitting diodes.

9. An electrical power monitor as recited in claim 8 further comprising a battery monitor that adjusts the duty cycle of the flashing light emitting diodes in response to the remaining battery capacity.

10. An electrical power monitor as recited in claim 1 wherein the battery is a rechargeable battery and the electrical power monitor further comprises a battery charger connected to the battery.

11. An electrical power monitor as recited in claim 1 further comprising:
at least one sensor responsive to a performance parameter of an electrical device connected in parallel with the power monitor; and,
an alarm configured to activate if the value of the performance parameter exceeds a pre-set limit.

12. An electrical power monitor as recited in claim 10 wherein the sensor is a temperature sensor.

13. A refrigerator/freezer monitor comprising:
a line power detector;
a power failure duration timer connected to the line power detector such that the timer starts when the line power detector detects a line power failure and stops when the line power detector detects a restoration of line power;
a display connected to the timer that displays the timer count;
a battery connected to the timer and the display such that the battery supplies power to the timer and the display during line power failures;
an alarm;
a first temperature sensor;
a second temperature sensor;
a comparator connected to the first temperature sensor and the second temperature sensor and the alarm and configured to compare a temperature reading from the first temperature sensor to a first pre-set value and to compare a temperature reading from the second temperature sensor to a second pre-set value and to activate the alarm if either temperature reading exceeds its respective, pre-set value.

14. A refrigerator/freezer monitor as recited in claim 13 wherein the alarm is also connected to the line power detector and the alarm is activated when the line power detector detects a line power failure.

15. A refrigerator/freezer monitor as recited in claim 13 further comprising a battery charger connected to the battery.

16. A refrigerator/freezer monitor as recited in claim 13 further comprising a line power cord having a unitized plug comprising a male connector and a female receptacle in parallel electrical connection.

17. A refrigerator/freezer monitor as recited in claim 13 wherein the alarm is an audible alarm.

18. A refrigerator/freezer monitor as recited in claim 13 wherein the alarm is a visual alarm.

19. A method for monitoring the power supplied to an electrically powered device comprising:
sampling the line power voltage supplied to an electrically powered device with a line power detector;
starting a power failure duration timer when a line power detector detects a line power failure;
stopping a power failure duration timer when a line power detector detects a restoration of line power; and,
displaying the power failure duration timer count on a display device.

20. A method as recited in claim 19 further comprising switching a power supply connected to the timer from line power to battery power when the line power detector detects a line power failure.
